(19) United States
(12) Patent Application Publication
(10) Pub. No.: US 2005/0060251 A1
(43) Pub. Date: Mar. 17, 2005

(54) Annuity product and method of implementing the same

(76) Inventors: Jesse Schwartz, New York, NY (US); Michael Wadsworth, Great Bookham (GB)

Correspondence Address: Daniel H. Shulman;Mayer, Brown, Rowe & Maw LLP, P.O. Box 2828, Chicago, IL, 60690-2828, US

(21) Appl. No.: 10/651,236

(22) Filed: Aug. 28, 2003

(51) Int. Cl. G06F 17/60

(52) U.S. Cl. 705/35

(57) ABSTRACT

An annuity product for paying out a desired periodic income payment to an annuitant including, without limitation: a deposit amount determined based on at least the desired periodic income payment, the age of the annuitant, a term comprising a guaranteed period for payment of the desired periodic income payment, an interest rate, and a mortality probability; and an income annuity balance reflecting debits and credits to the deposit amount; wherein the annuity balance is periodically debited due to income payments and periodically credited due to interest accrual; wherein the annuity balance is calculated on a periodic basis; and wherein a statement disclosing the annuity balance is provided to the annuitant on a periodic basis.

### BACKGROUND OF THE INVENTION

1. Field of the Invention

The present invention relates to a life insurance product. Particularly, the present invention relates to an annuity product and method of implementing the same that includes periodic payments and the calculation of an income annuity account balance.

2. Description of Related Art

Historically, retirement income plans consisted of a person's employer sponsored defined benefit pension plan supplemented by social security and personal savings. The defined benefit pension plan provided a specific guaranteed benefit (often based on years of service and salary level) for life after retirement. Defined contribution plans build funds for retirement but do not guarantee a specific income benefit at retirement.

At retirement, the retiree with defined contribution money and other funds saved for retirement faces a difficult choice of what to do with his retirement savings. It is likely that some income/liquidation of these assets will be necessary, but the amount needed immediately at retirement may not be enough later in life because income needs may change over time. The level of inflation, health status of the retiree, health status of a spouse or children and activity level will all influence how much income will be required. The retiree's income needs will also change significantly over time. There may be additional costs for a retirement home, personal nursing care, or other support in daily life. In addition, individuals will want to strike a balance between sustaining an adequate income for life and perhaps passing on unused assets to their heirs on death.

Retirees currently look to various current income products and methodologies (systematic partial withdrawals and fixed and variable income annuities) to provide retirement income. However, each of these products and strategies has significant disadvantages and problems as retirement income vehicles.

A systematic partial withdrawal strategy liquidates the accumulated assets over a period of years chosen to be equal to the life expectancy of the retiree. The main problem with this method is that life expectancy is a distribution and expected lifetime simply the mean or average number of years the retiree is expected to live. One of the main benefits of annuitizing, which the systematic partial withdrawal approach lacks, is the benefit of pooling of the risk of living longer than life expectance. Payments for people who live longer than average are supported by earlier than expected deaths of other annuitants. The retirees who live longer than average under the systematic partial withdrawal strategy will be in danger of outliving their assets. Unfortunately, this only becomes apparent late in life and the only available remedy at that time is to reduce the income amount to avoid entirely depleting the amount of assets available.

Fixed income annuities are sold by insurance companies and provide for a series of periodic payments for a certain number of periods that may be guaranteed (certain annuity), be over the lifetime of the annuitant (life contingent) or may be a combination of a number of guaranteed payments with life contingent payments thereafter (certain and life annuity). The life contingent payments may be for a single life or for two lives (joint life). For joint life annuities, payments may end at the first death, may reduce at the first death and end at the second death or may continue unreduced until the second death.

There are significant disadvantages with current fixed annuities. First, the income payment is a fixed amount that does not vary during the lifetime of the fixed annuity contract. There are some annuity policies that provide for regular increases to the annuity payment of a certain percentage amount (1, 2 or 3%) per year. These increases are sometimes called “Cost of Living Adjustments” or COLAs. A COLA provision is set at the beginning of the contract and does not change from year-to-year. Adding a COLA provision to a fixed annuity requires a significantly larger initial investment or a significant reduction in the initial payment amount. If the annuitant wishes to increase his or her income payment beyond the fixed payment which he or she has already purchased, he or she must purchase a brand new annuity contract. This is a significant disadvantage due to the high costs of policy issuance from commissions, application processing and policy form delivery. Furthermore, the annuitant will receive separate checks from the multiple annuities which is an administrative inconvenience. To make matters worse, there is no transparency to the annuitant concerning how the price of the annuity has been calculated. This is so because insurance companies do not treat annuity contracts like typical investment vehicles which demonstrate periodic activity. Because the interest rate used by the annuity provider is not disclosed to the annuitant up front and no periodic account activity is provided to an annuitant, the annuitant has no way to conceptualize whether the price being fixed (and guarantees provided) by the insurance company is competitive, or whether the annuity contract will be sufficient over time.

Accordingly, another drawback to a fixed income annuity is that when the annuity is purchased can have a dramatic effect of the level of payment. It is more expensive to purchase a specific amount of monthly income in a low interest rate environment compared to a higher interest rate environment. The exact level of interest rate assumed and the cost of the lifetime guarantee (if such a guarantee is chosen) is not disclosed to the purchaser so it is impossible to compare returns on fixed annuities. The uncertainty about whether it will be more advantageous to purchase a fixed annuity at a later date, limits the effectiveness of a fixed annuity product in the providing of retirement income.

Variable income annuities provide similar terms as fixed income annuities only the investment risk is borne by the annuitant. In a variable income annuity, an assumed interest rate (AIR) is used to determine the initial payment for the annuity. The annuitant selects one or more investment funds and the total weighted-average return is measured against the AIR. The income payments are increased if the average return on the investments chosen is greater than the AIR or decreased if the return is less than the AIR.

The variable income annuity provides the annuitant with exposure to alternative (equities and bonds) investments with the potential for improved returns and protection against inflation. The main drawback with variable income annuities is the variability of the income payments. Retirees are depending on stable income amounts and a significant drop in income due to poor performance from the underlying investment funds can be devastating to the retiree. This limits the effectiveness of the variable income annuity as retirement income tool.

Because no single retirement product exists with the flexibility and features necessary to meet retirees' needs, they often use a combination of strategies. Many retirees keep their current accumulation products and live off of partial withdrawals. This technique is not tax efficient and has proven to be unsuccessful if the retiree lives too long or has poor investment performance, especially in the years just after retirement. Some retirees use a portion of their retirement assets to purchase fixed annuities, locking into a fixed payment without understanding if they are getting a good deal or not. The purchasing power of their fixed payment will decrease with inflation and they will have to enter into a new contract if they want to increase their payment in the future. Some will purchase variable income annuities, with the accompanying variability in the income payments from year-to-year. The invention described below, provides flexible, guaranteed income payments in one easy-to-understand product that meets the retiree's changing needs throughout the rest of his or her lifetime.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

It is an object of embodiments of the invention to provide a flexible income annuity. It is a further object of embodiments of the invention to provide an annuity product that combines an accumulation and income vehicle in a single offering.

To achieve these and other objects, and in accordance with the purpose of the invention, as embodied and broadly described, an embodiment of the invention includes an annuity product for paying out a periodic income payment to an annuitant comprising: a deposit amount determined based on at least a desired periodic income payment, a term comprising a guaranteed period for payment of the periodic income payment and an interest rate; and an income annuity balance reflecting debits and credits to the deposit amount; wherein the income annuity account balance is periodically debited and periodically credited; and wherein the income annuity account balance is calculated on a periodic basis.

The invention also includes a method for implementing an annuity product comprising: creating an income annuity account balance, the income annuity account balance initially being a deposit amount, wherein the deposit amount is determined based on at least a periodic income payment desired by an annuitant, a term comprising a guaranteed period for payment of the periodic income payment, and an interest rate; crediting the income annuity account balance; making the periodic income payment and debiting the income annuity account balance by the amount of the periodic income payment; and periodically re-calculating the income annuity account balance based on debits and credits made during the period.

It is further envisioned that embodiments of the invention may be implemented in computer software. Thus, another embodiment of the invention includes a computer readable medium containing programming instructions for a method for implementing an annuity product, the method comprising: creating an income annuity account balance, the income annuity account balance initially being a deposit amount, wherein the deposit amount is determined based on at least a periodic income payment desired by an annuitant, a term comprising a guaranteed period for payment of the periodic income payment and, an interest rate; crediting the income annuity account balance; making the periodic income payment and debiting the income annuity account balance by the amount of the periodic income payment and other debits; and periodically re-calculating the income annuity account balance based on debits and credits made during the period.

Another embodiment of the present invention includes an annuity product comprising: an income annuity account; and an accumulation account; wherein the income annuity payments may be funded through transfers from the accumulation account.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 shows an illustrative annual statement for an annuity product in accordance with an embodiment of the invention.

FIG. 2 depicts predicted performance of an income annuity with survivor bonus for an annuitant at the age of 65 according to an embodiment of the invention.

FIG. 3 depicts predicted performance of an income annuity with survivor bonus for an annuitant at the age of 85 according to an embodiment of the invention.

FIG. 4 illustrates the review cycle of the income account of the present annuity product according to an embodiment of the invention.

FIG. 5 shows an income account being funded by an accumulation account in accordance with an embodiment of the invention.

FIG. 6 depicts an automatic conversion to an income annuity according to an embodiment of the invention.

FIG. 7 is a schematic representation of a set of programming instructions according to an embodiment of the invention.

### DETAILED DESCRIPTION OF THE PREFERRED EMBODIMENT

Reference will now be made in detail to the present preferred embodiments of the invention, examples of which are described herein.

The invention comprises embodiments of a new annuity product that can provide both accumulation and income features in one product. According to a preferred embodiment, there are two accounts, an accumulation account and an income account, that are separately identified and have separate account balances. The product remains in force if there is a positive balance in either of the two accounts.

The accumulation account (if it has a positive balance) operates like a variable deferred annuity. It has all of the features of a variable deferred annuity such as the ability to invest the balance in various separate accounts. There are many other features of a variable annuity that would be part of the accumulation account such as guaranteed minimum death benefits, surrender charges, mortality and expense fees and other guarantees. The income account funds temporary or lifetime income to an individual through the purchase of a temporary or lifetime annuities. In this embodiment, the annuity product is funded through a transfer into an income account from the accumulation account or a deposit from some other source (e.g., premium payment or link to other funds in an accumulation account). In a preferred embodiment, the amount of the transfer or deposit necessary is determined depending on the number of guaranteed payments, the interest rate provided by the company (for a fixed immediate annuity the interest rate is fixed, for a variable immediate annuity, the assumed interest rate is used) and the mortality guarantee provided (if any). The following formula presents the means for calculating the deposit amount:

$$D eposit = {\sum }_{n = 1}^{t} {Pmt}_{n} * {v}^{n} * {}_{n}^{}{p}{}_{x}^{( 12 )} \qquad Formula 1 \text{:}$$

Pmtₙ=Guaranteed payment for month n
x=Attained age at date deposit is being determined
t=Guarantee period (in months)
v=1/(1+I)
I=If fixed immediate annuity, then (1+i)^{(1/12)}−1
   If variable immediate annuity, then (1+AIR)^{(1/12})−1
i=Annual guaranteed interest rate declared by the company at beginning of guaranteed period
AIR=Assumed annual interest rate chosen by the annuity owner (e.g., 5%)
ₙpₓ⁽¹²⁾=Probability that a person aged x will live n months (ₙPₓ⁽¹²⁾=1, if no mortality guarantee exists) based on mortality table determined by the annuity company

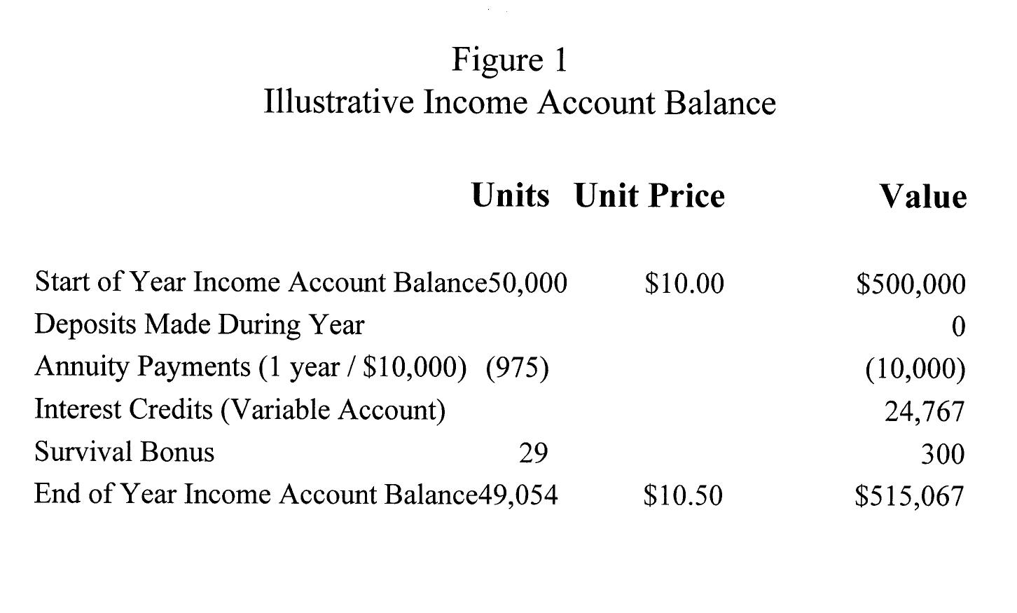

The income account balance at time n (IABₙ) is increased by deposits made, interest credits and survivor bonus (if any) and reduced for annuity payments and any withdrawals as shown in Formula 2. FIG. 1 shows an illustrative annual statement for an annuity product in accordance with an embodiment of the invention. The income account balance at the beginning of the year is shown followed by additions to the account of deposits, interest and survival bonus credit amounts and subtractions from the account of income payments made and partial surrenders.
IABₙ₊₁=IABₙ+Dₙ+INTₙ+SBₙ−Pmtₙ−Wₙ Formula 2:
IABₙ=Income Account Balance at time n
Dₙ=Deposits made during period n
INTₙ=Interest credited during period n
SBₙ=Survivor bonus during period n
Pmtₙ=Payment made during period n
Wₙ=Partial withdrawals during period n

According to the preferred embodiments, additional deposits into the annuity product are allowed at any time after inception of the contract. These additional deposits are directed by the annuity owner to the income account to increase the income payments or to the accumulation account for accumulation purposes. The portion of the new deposit (Depositₙ) directed to the income account is used to increase the initial income amount by Pmtₙ′. Pmtₙ′ is determined using interest and survivor bonus guarantees declared by the insurance company at the time of the deposit. The additional income payments can be structured to coincide with the other income payments from the contract (resulting in one payment per month) or may be paid on different dates as chosen by the annuity owner. The additional income payment amount (Pmtₙ′) is defined according to the following formula:

$${Pmt}_{n}^{′} = {Deposit}_{n} / {\sum }_{n = 1}^{t} {v}^{n} * {}_{n}^{}{p}{}_{x}^{( 12 )} \qquad Formula 3 \text{:}$$

Pmtₙ′=Additional payment beginning in month n
Depositₙ=Amount of deposit into the income account in month n
x=Attained age at date deposit is made
t=Guaranteed period for deposit (in months)
v=1/(1+I)
I=If fixed immediate annuity, then (1+i)^{(1/12)}−1
   If variable immediate annuity, then (1+AIR)^{(1/12)}−1
i=Annual guaranteed interest rate declared by the company at time of deposit
AIR=Assumed annual interest rate chosen by the annuity owner (e.g., 5%)
ₙpₓ⁽¹²⁾=Probability that a person aged x will live n months (ₙpₓ⁽¹²⁾=1, if no mortality guarantee exists) based on mortality table determined by the annuity company

The portion, if any, of the additional deposit that is not used to increase the income payments is deposited into the accumulation account.

The interest rate applied to the income account balance each period can be a fixed rate, a variable rate or any combination of the two. The company would declare a fixed rate of interest that would vary by the duration of the guarantee period and the date the money was deposited in the account. The fixed rate could be declared at the beginning of the guaranteed period, the beginning of the contract or declared each year. The declared rate on the accumulation account could be the same as the income account or could be different. The declared rate would apply to all funds deposited at the beginning of a guaranteed period. The declared rate may also apply to new deposits, or a different interest rate may be declared for deposits made after the beginning of the guaranteed period. Assuming the same interest rate applies to the entire balance and interest is credited on a daily basis, the following formula is exemplary:
INT_{N}=IABₙ*[(1+i)^{(1/365)}−1 Formula 4:

In some embodiments, all or a portion of the income account balance can be allocated among specific investment funds (similar to a variable immediate annuity). The investment return on these investment funds is not guaranteed and the interest credited on the account depends on the performance of the investment funds chosen. According to unique aspects of the present invention, if a variable immediate annuity is chosen, the annuity owner has two choices for the income payments. One choice would be that the income payments would be increased or decreased each period depending on the investment fund performance versus the AIR, like a traditional variable immediate annuity, according to the following exemplary formula:
Pmtₙ=Pmtₙ₋₁*[(1+Iᵥₐᵣ)/(1+AIR)^{(1/Period)}] Formula 5:
Iᵥₐᵣ=Calculated interest rate earned on investment funds for the period
period=1 if annual processing or 12 if monthly processing

Alternatively, and according to a novel aspect of embodiments of the present invention, the annuity owner can choose to have the income payments continue at the same level notwithstanding the investment return each period. Under this scenario, the annuity owner has the further choice of modifying the term of the fixed payments or keeping the term of the payments the same. Under the term modification option, payments will be made as long as the income account has sufficient funds to make the required payments after additions and deductions are made. If the income account balance becomes equal to or less than the amount of the income payment, an additional deposit would be required to continue the income payments or the income payments would cease. Another option would be to keep the term of the payments fixed. Under this option, an additional transfer or deposit into the income account may be required if investment experience is less than expected. Because the present invention permits additional deposits into an existing annuity product, the problem of having to purchase a new annuity product on potentially less favorable terms is avoided. As discussed, this capability is a direct consequence of keeping a running income annuity account balance on the product.

In certain embodiments, if another deposit is made after the guaranteed period has begun, a new fixed guaranteed interest rate can be declared unless the deposit goes into variable separate accounts. The calculation of INT_{N} for the portion of the income account balance attributable to the new deposit with fixed interest is the same as in Formula 3 with i equal to the new declared guaranteed interest rate.

Another unique and novel option available in embodiments of the present invention is to convert a variable immediate annuity income stream to a fixed immediate annuity. This option would be available at any time during the guaranteed period if the income account balance (IAB) were greater than zero. The new fixed income payment would be calculated using the current guaranteed fixed interest rate for the remaining guaranteed period. Upon the conversion request, the insurance company would calculate a value representing the deposit necessary to fund current income payment for the remaining guaranteed period. Formula 1 would be used but the guaranteed interest rate (i) would equal the current guaranteed fixed interest rate declared by the insurance company for the remaining guaranteed period. If the income account balance (IAB) at the time of the conversion request were greater than the required deposit amount, then an increased guaranteed income payment would be available. A refund of the difference may also be available although a surrender charge may apply. If the IAB were less than the required deposit amount, then an additional deposit would be necessary to keep the income payment at the same level or a reduced income payment would be calculated. Again, the unique features described above are made possible according to the novel feature of the invention that income annuity account balances are periodically calculated and known during the life of the product. Where such information is not known or calculated, as in the case of current income annuity products, the conversion described herein is neither feasible nor possible.
Pmt′=Pmtᵣ*[IABᵣ/Deposit′] (if new payment amount is chosen) Formula 6:

$${Deposit}^{′} = {\sum }_{n = 1}^{t - r} {Pmt}_{r} * {v}^{n} * {}_{n}^{}{p}{}_{x + r}^{( 12 )}$$

where vⁿ is calculated using i′
i′=Current guaranteed interest rate for new fixed interest annuities with a period of [t−r]
   Required Deposit−Deposit′−IABᵣ (if Deposit′>IABᵣ) Formula 7:
   Free Account Balance=IABᵣ−Deposit′ (if IABᵣ>Deposit′) Formula 8:

The income portion of the annuity product of the present invention may have fully or partially life contingent or certain payments. In preferred embodiments, at the beginning of a guarantee period, the annuity owner selects a vector of life contingent percentages (LC), ranging from 0% to 100% inclusive that will apply during the term of the guarantee period. The life contingent percentage can vary from period to period during the guarantee period. Once set, this percentage does not change until the end of the guarantee period. For example, if the annuitant wanted five years of certain payments, five years of 50% certain and 50% life contingent and life contingent payments thereafter on a 20-year guaranteed income annuity, the life contingent percentage would be 0% for 5 years, 50% for five years and then 100% thereafter. This is only one example, as any combination of life contingent payments would be available. The flexibility of being able to chose any combination of life contingent payments is a unique and novel feature of this invention.

If the annuity owner chooses a life contingent percentage greater than 0% for any period, a survivor bonus is credited to the income account balance depending on the status of the annuitant(s) at the end of the period. The single life survivor bonus at time n (SBₙ) is equal to the annuity amount at risk (AARₙ) multiplied by a factor representing the mortality guarantee, if any, used to determine the initial deposit. The company may declare an additional survivor bonus (DIVₙ) if mortality experience is better than what was used to determine the initial deposit. The declaration of the survivor bonus to the consumer up front and the potential that the insurance company will declare an additional survivor bonus where both items are added to the income account balance is a feature that is novel and unique to this invention. The formulas below assume that the survivor bonus is credited monthly to the income account balance. Other periods, such as annual crediting, are also possible and would be simple manipulations of the formulas. Formula 9 provides a means for calculating a survivor bonus. Formula 10 provides a means for calculating the annuity amount at risk. As can be seen from the below preferred embodiments, the formulas allow the annuity issuer to disclose expected survivor bonuses to the annuitant either up front or at any time during the life of the annuity product.
SBₙ=AARₙ*(1+I)*[1/(1−qₓ₊ₙ⁽¹²⁾)−1]+DIVₙ (single life formula) Formula 9:
AARₙ=Annuity amount at risk at time n
I=If fixed immediate annuity, then (1+i)^{(1/12)}−1
   If variable immediate annuity, then monthly interest rate earned on assets underlying the income account balance
i=Annual guaranteed interest rate declared by the company at time of deposit
qₓ₊ₙ⁽¹²⁾=Probability that a person age x+n will die within next month based on mortality table determined by the annuity company
DIVₙ=Additional survivor bonus declared by the company, if any, for period n

$${AAR}_{r} = {\sum }_{n = 1}^{t - r} {Pmt}_{n + r - 1} * {LC}_{n + r - 1} * {v}^{n} * {}_{n}^{}{p}{}_{x + r}^{( 12 )} \qquad Formula 10 \text{:}$$
t=Guarantee period (in months)
r=Number of months from beginning of guarantee period (valuation month)
Pmtₙ=Guaranteed payment for month n
LCₙ=Life contingent percentage for period n (number from 0% to 100% inclusive)
v=1/(1+I)
I=If fixed immediate annuity, then (1+i)^{(1/12)}−1
   If variable immediate annuity, then (1+AIR)^{(1/12)}−1
i=Annual guaranteed interest rate declared by the company at beginning of guaranteed period
AIR=Assumed annual interest rate chosen by the annuity owner (e.g., 5%)
x=Attained age at beginning of guarantee period
ₙpₓ₊ᵣ⁽¹²⁾=Probability that a person aged x+r will live n months based on mortality table determined by the annuity company
   Upon the death of the annuitant, the life contingent income payments end but all non-life contingent guaranteed payments continue. The Forfeit Amount (FAₙ) equal to the Annuity Amount at Risk (AARₙ) is deducted from the Income Account Balance (IAB) upon the death of the annuitant.
   FAₙ=AARₙ*Death Indicator Formula 11:
Death Indicator=1, if death of the annuitant in period n
Death Indicator=0, for all other cases
   The above formulas apply for payments based on the survival of a single life. Other annuity types, such as a joint and last survivor immediate annuity and other forms would also be available. In a joint life immediate annuity, an additional selection of the amount of the initial payment that will continue after the first death (RPₙ) is necessary. As with the life contingent percentage, this amount is set at the beginning of the guarantee period, could vary from period-to-period but could not be changed until the end of the guarantee period. The ages of the joint lives would be used to calculate the initial deposit required and the survivor bonus amounts, if any.
   SBₙ=^{x}RPₙ*^{x}SBₙ+^{y}RPₙ*^{y}SBₙ+(1−^{x}RPₙ−^{y}RPₙ)*^{xy}SBₙ+DIVₙ Formula 12:
(Joint and last survivor formula)
x=Attained age of primary annuitant at beginning of guarantee period
y=Attained age of joint annuitant at beginning of guarantee period
^{x}SBₙ and ^{y}SBₙ are calculated using Formula 9, the single life formula with a modification to Formula 10. In Formula 10 to calculate AARₙ in the calculation of ^{x}SBₙ, the term Pmtₙ₊ᵣ₋₁ is replaced by (Pmtₙ₊ᵣ₋₁*^{x}RPₙ₊ᵣ₋₁). In Formula 10 to calculate AARₙ in the calculation of ^{y}SBₙ, the term Pmtₙ₊ᵣ₋₁is replaced by (Pmtₙ₊ᵣ₋₁*^{y}RP_{n+r-1).}
^{x}RPₙ=Percentage of the initial income payment paid after death of life y in period n if x is still alive
^{y}RPₙ=Percentage of the initial income payment paid after death of life x in period n if y is still alive
DIVₙ=Additional survivor bonus declared by the company, if any, for period n
   ^{xy}SBₙ=^{xy}AARₙ*(1+I)*[(1/p_{(x+n):(y+n)}⁽¹²⁾)−1] Formula 13
^{xy}AARₙ=Joint life annuity amount at risk at time n
I=If fixed immediate annuity, then (1+i)^{(1/12)}−1
   If variable immediate annuity, then monthly interest rate earned on assets underlying the income account balance
i=Annual guaranteed interest rate declared by the company at time of deposit
p_{(x+n):(y+n)}⁽¹²⁾=Probability that two people age x+n and age y+n will both live for one month based on mortality table determined by the annuity company

$${}_{}^{xy}{AAR}{}_{r}^{} = {\sum }_{n = 1}^{t - r} ( 1 - {}_{}^{x}{RP}{}_{n}^{} - {}_{}^{y}{RP}{}_{n}^{} ) * {Pmt}_{n + r - 1} * {LC}_{n + r - 1} * {v}^{n} * {}_{n}^{}{p}{}_{x + r : y + r}^{( 12 )} \qquad Formula 14 \text{:}$$
t=Guarantee period (in months)
r=Number of months from beginning of guarantee period (valuation month)
Pmtₙ=Guaranteed payment for month n
LCₙ=Life contingent percentage for period n (number from 0% to 100% inclusive)
v=1/(1+I)
I=If fixed immediate annuity, then (1+i)^{(1/12)}−1
   If variable immediate annuity, then (1+AIR)^{(1/12)}=1
i=Annual guaranteed interest rate declared by the company at beginning of guarantee period
AIR=Assumed annual interest rate chosen by the annuity owner (e.g., 5%)
ₙp_{x+r:y+r}⁽¹²⁾=Probability that two people, age x+r and age y+r, will both live n months based on mortality table determined by the annuity company
   If both annuitants are living and one dies during the period, the life contingent income payments continue equal to PMTₙ*^{x}RPₙ if the joint annuitant y dies or PMTₙ*^{y}RPₙ if the primary annuitant x dies. All non-life contingent guaranteed payments continue. The Forfeit Amount (^{\overline{xy}}FAₙ) deducted from the Income Account Balance (IAB) varies depending upon which annuitant dies.

If both annuitants are alive at the beginning of the period:
FAₙ=(^{x}AARₙ+^{xy}AARₙ)*^{x}Indicatorₙ+(^{y}AARₙ+^{xy}AARₙ)*^{y}Indicatorₙ Formula 13
^{x}Indicatorₙ=1, if death of the primary annuitant, x, in period n
^{x}Indicatorₙ=0, if the primary annuitant, x, survives to the end of period n
^{x}Indicatorₙ=1, if death of the joint annuitant, y, in period n
^{x}Indicatorₙ=0, if the joint annuitant, y, survives to the end of period n
   After the death of one annuitant with the other annuitant still alive, Formulas 9, 10 and 11, the single life formulas, are used to calculate the SBₙ, AARₙ and FAₙ.

If both annuitants are living and both die during period n, then all life contingent payments end and only the non-life contingent guaranteed payments continue. The Forfeit Amount is equal to:
FAₙ=(^{x}AARₙ+^{y}AARₙ+^{xy}AARₙ)*^{xy}Indicatorₙ Formula 16:
^{xy}Indicatorₙ=1, if death of both primary and joint annuitant in period n
^{xy}Indicatorₙ=0, if both annuitants survive to the end of period n

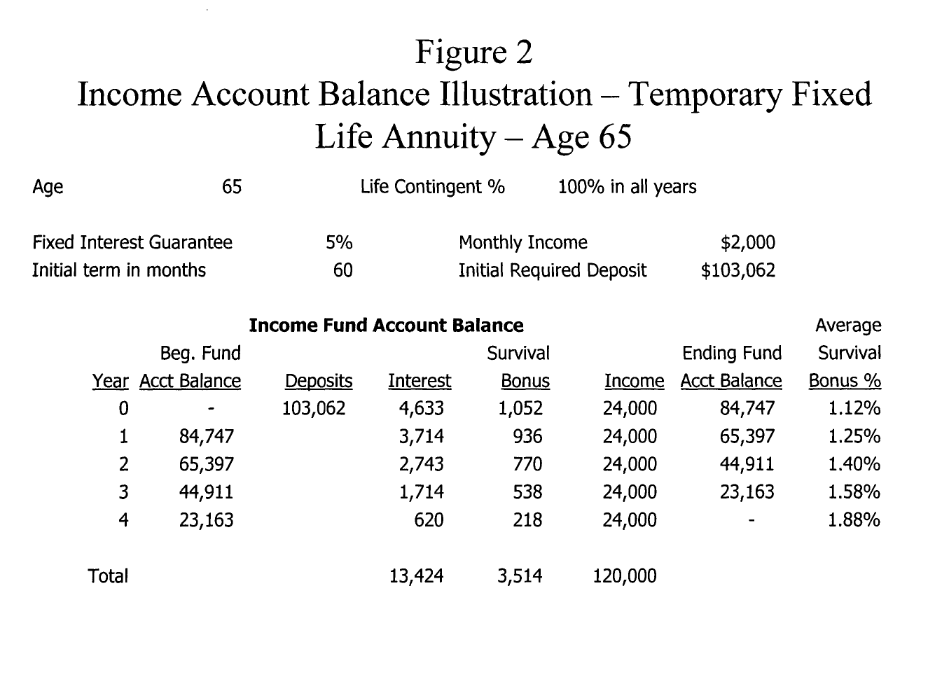

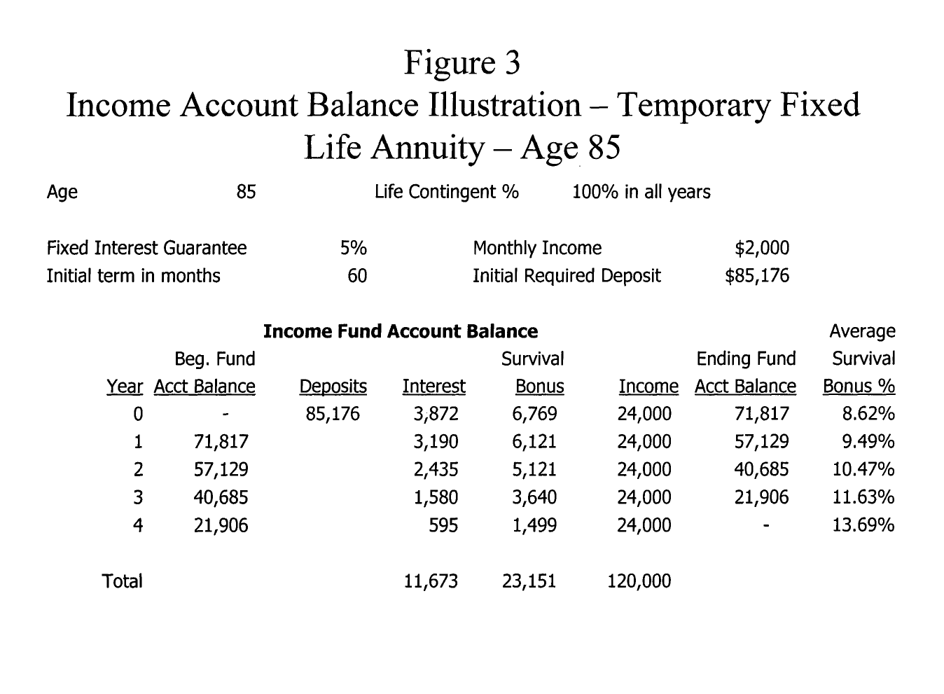

The use of the Survivor Bonus feature in conjunction with the periodic calculation and reporting of the income annuity account balance affords significant advantages over the prior art. One such advantage is predictability and understanding of income annuity performance. This advantage is shown in the comparison of FIG. 2 and FIG. 3. FIG. 2 depicts predicted performance of an income annuity with survivor bonus for an annuitant at the age of 65. FIG. 3 shows a similar annuity product for a annuitant aged 85. As can be seen, the periodic balance statements allow an annuitant to evaluate the relative values of different products at different stages of life. Thus, an annuitant can decide whether a better value exists in purchasing a period certain product for a particular amount or whether it would make more sense to, for example, combine a period certain product with a life contingent product because the deposit amount necessary for a life contingent product will be less. As can be seen, both mutual deposit amounts and product performance are easily determined according to the present invention.

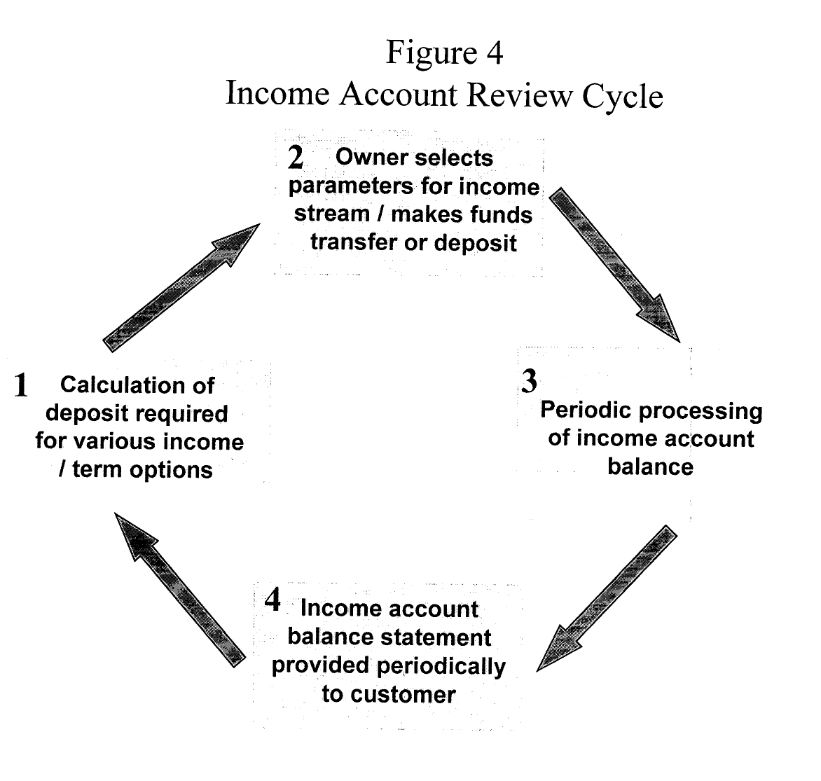

Because account balances are periodically identified, another advantageous feature of embodiments of the invention is the possibility of a review of the income account at the end of the guarantee period if the guarantee period chosen is less than a lifetime period. At this review, the annuitant can choose a new guarantee period and income amount for the new temporary or lifetime income annuity. There would also be an automatic or default option that could be applied at the end of the guaranteed period at the option of the annuity owner. FIG. 4 illustrates the review cycle of the income account of the present annuity product. The insurance company calculates the cost of a standard payment amount (say $1,000 of monthly income) for various guarantee period choices (see Formula 1 above) based on the parameters provided by the potential customer such as age and sex of the annuitant(s) and type of annuity desired. If a life contingent annuity is desired, the guaranteed survivor bonuses are also provided. The customer chooses the parameters for the annuity product and the required amount is deposited into the income account becoming the initial income account balance.

On a periodic basis, the insurance company adjusts the income account balance (see Formula 2 above) for account activity during the period. This process continues until the end of the guarantee period. At the end of the guarantee period, the process repeats itself as the company then provides updated costs and survivor bonuses for several guarantee periods. The new parameters for the income payments are chosen and the additional funds required are transferred or deposited into the income account balance to begin the new period of income payments.

A unique feature of the invention is the provision of a free account balance that enables many of the features of embodiments of the invention. The free account balance in the income account at any time is equal to the amount in the income account balance (IAB) less the required amount necessary to pay all remaining guaranteed income payments at the guaranteed interest rate and assuming the guaranteed survivor bonus, if any.
FABᵣ=IABᵣ−Deposit″ Formula 17:

$${Deposit}^{″} = {\sum }_{n = 1}^{t - r} {Pmt}_{n + r} * {v}^{n} * {}_{n}^{}{p}{}_{x + r}^{( 12 )}$$

(All variables defined as in Formula 1)

A free account balance greater than zero would occur in two situations: (1) when a mortality bonus greater than the guaranteed amount is declared, or (2) when variable income payments are chosen with the term fixed and greater than expected investment experience occurs. The annuity owner can choose to have free account balance amounts be transferred to an accumulation account, applied to increase the guaranteed income payments or paid out as income on regular intervals. There may also be the ability to withdraw the free account balance (a surrender charge may apply). The default option for the application of the free account balance should be chosen at the inception of the contract, but can be changed at any time. If the free account balance is applied to increase the guaranteed income payments, then this begins a new income payment stream that is calculated using Formula 3 above. This additional income payment stream can be matched to the timing and duration of the current guaranteed payments so the annuitant receives only one check each period from the annuity. This treatment may be desirable but is not required as the new guaranteed period and timing of the payment is flexible.

It is possible to include a withdrawal (or commutation) option from the income account. The withdrawal option may not be available depending on the characteristics of the contract, but could be offered. Withdrawals of the free account balance are available as described above. Other available withdrawals would be amounts remaining in the income account at the end of the guarantee period and any amounts in the accumulation account (a surrender charge may apply). A withdrawal of the fund balance that has been used to generate guaranteed income amounts is possible but would require protection against anti-selection by the annuity owner. There are both mortality and interest rate anti-selection risks with incorporating a withdrawal option to the present product.

There is no mortality anti-selection risk if the withdrawal option only applies to the income account balance (IAB) that arises due to future payments that are not life contingent. The income account balance that is not dependent on life contingencies, the certain account balance (CAB), is defined as the excess of the income account balance over the annuity amount at risk (AAR). The ability to withdraw or commute only the certain payments of an annuity that has both life contingent and certain payments is novel and unique to this invention.
CABₙ=IABₙ−AARₙ Formula 18:
(where AARₙ is either single or joint life as appropriate)

There would still be the potential for interest rate anti-selection of the certain account balance. The application of some combination of a market value adjustment (MVA), surrender charge, commutation value charge or some other type of charge that applied upon surrender would be necessary to protect against such risk.

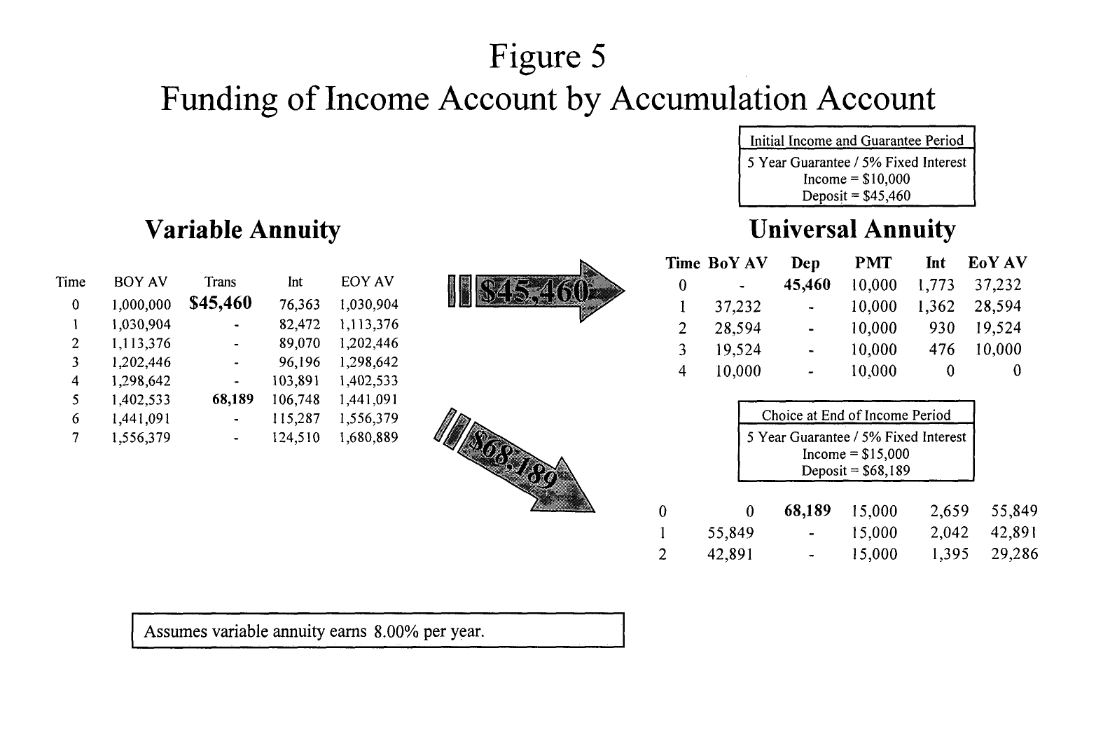

As described above, the present annuity product can be used as an accumulation vehicle by making deposits into the accumulation account without choosing any income payments or making larger deposits than what is needed to fund the guaranteed income payments and allocating the remainder into the accumulation account. Another way to provide funds for the income annuity would be to link the income annuity with an accumulation account, such as brokerage account or bank account, in a split-funded arrangement. For example, the annuity product could be funded using deposits into the accumulation account. The funds from the accumulation account balance would be transferred to the income account (see FIG. 5) to fund the income payments.

FIG. 5 shows the income account being funded by the accumulation account. In this example, the initial choice made by the annuity owner of a five-year guarantee and $10,000 per year of income is shown in the upper right side of FIG. 5. It is assumed that no life contingent payments were chosen (i.e., LC=0%) and a guaranteed interest rate of a 5% was declared. The required deposit for this temporary immediate annuity was determined by the company to be equal to $45,460. This amount is transferred from the accumulation account as the initial deposit into the income account.

The income account balance is adjusted for interest earnings, payments and other items on a periodic basis and decreases to zero (with the assumption of no additional deposits) at the end of the guarantee period. At the end of the guarantee period, the annuity owner chooses another five-year guarantee period with an increase in the income payments from $10,000 to $15,000 per year. The required deposit of $68,189 is transferred from the accumulation account to fund this new series of income payments.

A guarantee of a minimum lifetime income amount could be provided in the present annuity product. If this option were chosen, the annuity owner would choose the income amount for the guarantee. Formula 1 would be used to calculate the required deposit to fund the lifetime income amount using the lifetime guaranteed payment, a guaranteed period of life and current interest and survival probability rates determined by the company. A vector of deposit amounts, representing the cost of a life annuity for the guaranteed income amount over the lifetime of the annuity, would be calculated. Current assumptions for guaranteed interest and mortality assumptions would be used in the calculation. If the company modifies these assumptions in the future, then a new vector is calculated.

The current available fund balance, (either in the income account or the combined income account plus accumulation account), would be compared to the current cost of the life annuity on a continuous basis. If the fund balance were greater than the current cost of the life annuity, the income annuity would continue to operate in its normal fashion. If at any time, the current fund balance is equal to the current price of the lifetime guaranteed annuity amount a life annuity for the guaranteed income amount would be automatically purchased. At that point, the entire current fund balance would be used to purchase a guaranteed income stream for life leaving no remaining account balance in either account.

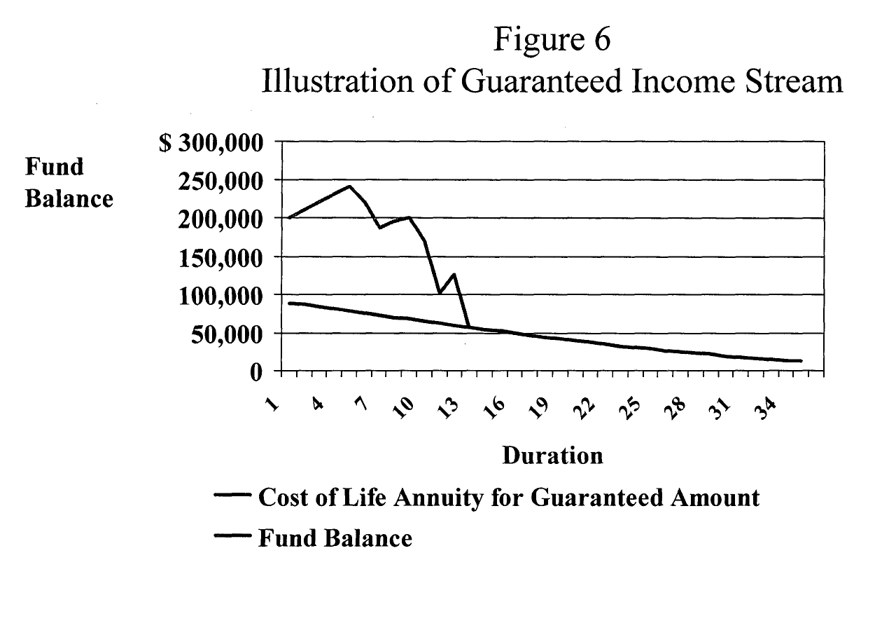

FIG. 6 illustrates this process. Initially, no action is taken since the fund balance is higher than the current cost of the life annuity for the minimum guaranteed income amount. In year 13, the total fund balance has dropped to the level of the current cost of the life annuity. At that point, there is an automatic annuitization thereby guaranteeing the minimum income payments for life. No fund balance remains after the point of the full annuitization.

During retirement, a person may have the needs for other insurance products such as long-term care insurance, medical insurance or life insurance. The income from the annuity could be used in total or in part to fund premium payments for other insurance products. For example, the income payments could be automatically used to pay the premiums for other insurance products. This would be a convenient and flexible way for the retiree to simplify their financial situation by using one product to fund other necessary insurance products during retirement. There would be tax advantages to this funding method versus direct premium payments or partial surrenders from retirement plans, as only a portion of the annuity income payments would be taxable to the annuitant.

From an insurance company perspective, the invention has significant advantages versus other income strategies. The invention helps insurance companies to manage their long-term mortality risk by providing an incentive to customers to purchase temporary life annuities instead of lifetime annuities. Long-term mortality guarantees are a very important issue today with life income annuities since companies do not have reliable data to predict the extent of future mortality improvement. Only a small increase in actual mortality improvement versus what was assumed in pricing the product can cause what was thought to be a profitably priced life income annuity to generate future losses due to longer survival of the annuitant than expected.

Many insurance agents do not sell income annuities because they are complicated and difficult to explain to the consumer. It is also difficult to determine whether or not the customer is getting a good deal since the interest rate and mortality guarantees are not disclosed. The invention is very easy to understand and has explicit assumptions that insurance agents can communicate in a simple way to the consumer. Furthermore, there is the ability to have additional options to pay commissions other than an initial percent of premium that is standard in an immediate annuity. Trail or asset-based commissions are not possible with a standard income annuity.

Finally, the invention is an all-in-one retirement product. It meets the needs of the consumer during the time the consumer is accumulating assets for retirement and during the period where the assets are used to provide income after retirement. This provides the insurance companies with a vehicle to retain retirement assets after the customer has retired and is looking to periodically liquidate their retirement funds instead of having to sell them a new product.

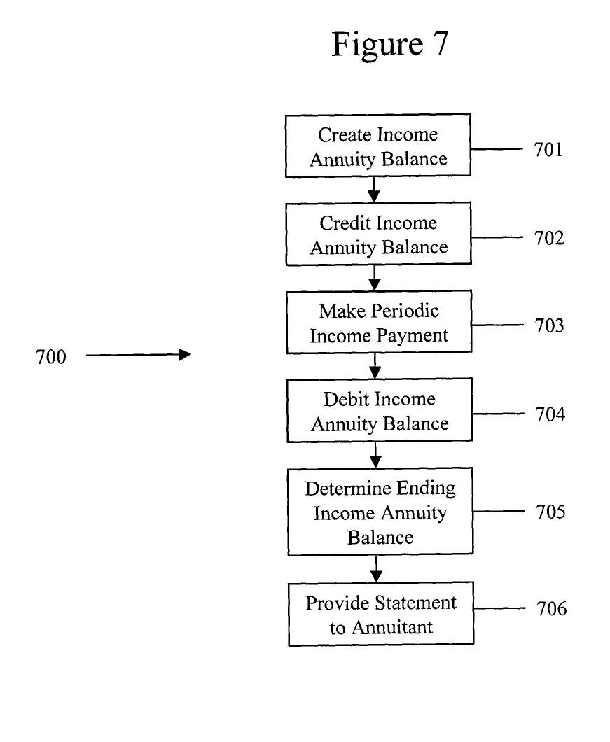

In particular preferred embodiments of the invention, the annuity and implementation thereof are managed through the use of computer software which performs the functions herein described. Accordingly, that embodiment includes a computer readable medium containing programming instructions 700 for a method for implementing the herein described annuity product. The instructions are depicted in FIG. 7 and would implement the present invention by creating an income annuity account balance 701. The income annuity account balance would initially comprise a deposit amount which is determined based on at least a periodic income payment desired by an annuitant, the age of the annuitant, a term comprising a guaranteed period for payment of the desired periodic income payment, an interest rate, and a mortality probability, all as set forth, for example, in Formula 1. The next step 702 would include crediting the income annuity account balance based on the interest rate, survivor bonus, or other credit event. According to the next steps, the program instructions would require making the desired periodic income payment 703 and debiting the income annuity account balance by the amount of the desired periodic income payment and other debits 704. The program would also contain instructions to periodically re-calculating the income annuity account balance based on debits and credits made during the period 705. Finally, the program would instruct the provision of a statement disclosing income annuity account balance activity to the annuitant 706. This feature could be met by printing out a balance statement and physically sending a copy to the annuitant, delivering the statement by electronic mail, making the statement available over the Internet, or other ways which may be convenient for the annuitant and the annuity provider.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

1. An annuity product for paying out a periodic income payment to an annuitant comprising:
a deposit amount determined based on at least a desired periodic income payment, a term comprising a guaranteed period for payment of income, and an interest rate; and
an income annuity balance reflecting debits and credits to the deposit amount;
wherein the income annuity balance is periodically debited and periodically credited; and
wherein the income annuity balance is calculated on a periodic basis.

2. The annuity product as claimed in claim 1 wherein the periodic income payment is fixed.

3. The annuity product as claimed in claim 1 wherein the periodic income payment is variable.

4. The annuity product as claimed in claim 1 further comprising a means for calculating a survivor bonus.

5. The annuity product as claimed in claim 1 wherein the survivor bonus is disclosed to an annuitant when the annuity product is purchased.

6. The annuity product as claimed in claim 1 wherein the interest rate is disclosed to an annuitant when the annuity product is purchased.

7. The annuity product as claimed in claim 1 further wherein a statement disclosing the income annuity balance is provided to the annuitant on a periodic basis.

8. The annuity product as claimed in claim 1 wherein the income annuity balance is periodically credit with a survivor bonus.

9. The annuity product as claimed in claim 1 wherein the interest rate is a guaranteed interest rate.

10. The annuity product as claimed in claim 1 wherein the interest rate used to determine the desired periodic income payment is an assumed interest rate and the periodic income payment varies based on the earnings of selected investment accounts versus such assumed interest rate.

11. The annuity product as claimed in claim 1 wherein the interest rate used to determine the desired periodic income payment is an assumed interest rate and the period for payment of income varies based on the earnings of selected investment accounts versus such assumed interest rate.

12. The annuity product as claimed in claim 1 wherein the desired periodic income payment may be increased during the term of the annuity product by adding an additional deposit amount to the income annuity balance.

13. The annuity product as claimed in claim 1 wherein at least a portion of periodic income payments is dependent on the survival of one or more lives.

14. The annuity product as claimed in claim 1 further comprising an accumulation account having an accumulation account balance.

15. The annuity product as claimed in claim 14 wherein the deposit amount is funded through the accumulation account.

16. The annuity product as claimed in claim 14 wherein an additional deposit amount is automatically transferred from the accumulation account into the income annuity balance if the income annuity balance reaches zero.

17. The annuity product as claimed in claim 14 wherein an additional deposit amount is automatically transferred from the accumulation account into the income annuity balance funding a guaranteed lifetime annuity if the sum of the income annuity balance and the accumulation account balance reaches a minimum amount necessary to provide a desired guaranteed income payment for the lifetime of an annuitant.

18. A method for implementing an annuity product comprising:
creating an income annuity account balance, the income annuity account balance initially being a deposit amount, wherein the deposit amount is determined based on at least a periodic income payment desired by an annuitant, a term comprising a guaranteed period for payment of the desired periodic income payment, and an interest rate;
crediting the income annuity account balance;
making a periodic income payment and debiting the income annuity account balance;
periodically re-calculating the income annuity account balance based on debits and credits made during the period.

19. The method as claimed in claim 18 wherein the periodic income payment is fixed.

20. The method as claimed in claim 18 wherein the periodic income payment is variable.

21. The method as claimed in claim 18 further comprising a step for calculating a survivor bonus.

22. The method as claimed in claim 21 further comprising disclosing the survivor bonus to an annuitant when the annuity product is purchased.

23. The method as claimed in claim 18 further comprising disclosing the interest rate to an annuitant when the annuity product is purchased.

24. The method as claimed in claim 18 further comprising providing a statement disclosing income annuity account activity to the annuitant.

25. The method as claimed in claim 18 further comprising crediting the income annuity account balance with a survivor bonus.

26. The method as claimed in claim 18 wherein the interest rate is a guaranteed interest rate.

27. The method as claimed in claim 18 wherein the interest rate used to determine the initial payments is an assumed interest rate and the periodic income payments varies based on the earnings of selected investment accounts versus such assumed interest rate.

28. The method as claimed in claim 18 wherein the interest rate used to determine the initial payments is an assumed interest rate and the period for payment of the desired periodic income payment varies based on the earnings of selected investment accounts versus such assumed interest rate.

29. The method as claimed in claim 18 further comprising adding an additional deposit amount to the income annuity balance to increase the desired periodic income payment during the term of the annuity product.

30. The method as claimed in claim 18 wherein at least a portion of the annuity product is dependent on the survival of one or more lives.

31. The method as claimed in claim 18 wherein the annuity product further comprises an accumulation account having an accumulation account balance.

32. The method as claimed in claim 31 further comprising funding the deposit amount through the accumulation account.

33. The method as claimed in claim 31 further comprising automatically transferring an additional deposit amount from the accumulation account into the income annuity balance if the income annuity balance reaches zero.

34. The method as claimed in claim 31 further comprising automatically transferring an additional deposit amount from the accumulation account into the income annuity balance funding a guaranteed lifetime annuity if the sum of the income annuity balance and the accumulation account balance reaches a minimum amount necessary to provide a desired guaranteed income payment for the lifetime of the annuitant.

35. A computer readable medium containing programming instructions for a method for implementing an annuity product, the method comprising:
creating an income annuity account balance, the income annuity account balance initially being a deposit amount, wherein the deposit amount is determined based on at least a periodic income payment desired by an annuitant, a term comprising a guaranteed period for payment of the desired periodic income payment, and an interest rate;
crediting the income annuity account balance;
making a periodic income payment and debiting the income annuity account balance;
periodically re-calculating the income annuity account balance based on debits and credits made during the period.

36. The computer readable medium as claimed in claim 35 wherein the periodic income payment is fixed.

37. The computer readable medium as claimed in claim 35 wherein the periodic income payment is variable.

38. The computer readable medium as claimed in claim 35 further comprising a step for calculating a survivor bonus.

39. The computer readable medium as claimed in claim 38 further comprising disclosing the survivor bonus to an annuitant when the annuity product is purchased.

40. The computer readable medium as claimed in claim 35 further comprising disclosing the interest rate to an annuitant when the annuity product is purchased.

41. The computer readable medium as claimed in claim 35 further comprising providing a statement disclosing income annuity account activity to the annuitant.

42. The computer readable medium as claimed in claim 35 further comprising crediting the income annuity account balance with a survivor bonus.

43. The computer readable medium as claimed in claim 35 wherein the interest rate is a guaranteed interest rate.

44. The computer readable medium as claimed in claim 35 wherein the interest rate used to determine the initial payments is an assumed interest rate and the periodic income payments varies based on the earnings of selected investment accounts versus such assumed interest rate.

45. The computer readable medium as claimed in claim 35 wherein the interest rate used to determine the initial payments is an assumed interest rate and the period for payment of the desired periodic income payment varies based on the earnings of selected investment accounts versus such assumed interest rate.

46. The computer readable medium as claimed in claim 35 further comprising adding an additional deposit amount to the income annuity balance to increase the desired periodic income payment during the term of the annuity product.

47. The computer readable medium as claimed in claim 35 wherein at least a portion of the annuity product is dependent on the survival of one or more lives.

48. The computer readable medium as claimed in claim 35 wherein the annuity product further comprises an accumulation account having an accumulation account balance.

49. The computer readable medium as claimed in claim 48 further comprising funding the deposit amount through the accumulation account.

50. The computer readable medium as claimed in claim 48 further comprising automatically transferring an additional deposit amount from the accumulation account into the income annuity balance if the income annuity balance reaches zero.

51. The computer readable medium as claimed in claim 48 further comprising automatically transferring an additional deposit amount from the accumulation account into the income annuity balance funding a guaranteed lifetime annuity if the sum of the income annuity balance and the accumulation account balance reaches a minimum amount necessary to provide a desired guaranteed income payment for the lifetime of the annuitant.

52. An annuity product comprising:
an income annuity product; and
an accumulation product;
wherein the payments made from the income account are funded through the accumulation product.

53. The annuity product as claimed in claim 52 wherein the income annuity product comprises:
an income annuity account balance, the income annuity account balance initially being a deposit amount deposited from the accumulation account, wherein the deposit amount is determined based on at least a periodic income payment desired by an annuitant, a term comprising a guaranteed period for payment of a periodic income payment, and an interest rate.

54. The annuity product as claimed in claim 52 wherein an income annuity product balance is periodically calculated based on debits and credits made during the period.

55. The annuity product as claimed in claim 54 wherein an additional deposit amount is automatically transferred from the accumulation product into the income annuity product if the income annuity balance reaches zero.

56. The annuity product as claimed in claim 54 wherein an additional deposit amount is automatically transferred from the accumulation product into the income annuity product funding a guaranteed lifetime annuity if the sum of the income annuity product balance and an accumulation account balance reaches a minimum amount necessary to provide a desired guaranteed income payment for the lifetime of the annuitant.

57. The annuity product as claimed in claim 52 further comprising a means for calculating a survivor bonus.

58. The annuity product as claimed in claim 53 wherein the periodic income payment is fixed.

59. The annuity product as claimed in claim 53 wherein the periodic income payment is variable.

60. The annuity product as claimed in claim 57 wherein the survivor bonus is disclosed to an annuitant when the annuity product is purchased.

61. The annuity product as claimed in claim 53 wherein the interest rate is disclosed to an annuitant when the annuity product is purchased.

62. The annuity product as claimed in claim 53 further wherein a statement disclosing the income annuity balance is provided to the annuitant on a periodic basis.

63. The annuity product as claimed in claim 52 wherein the income annuity balance is periodically credited with a survivor bonus.

64. The annuity product as claimed in claim 53 wherein the interest rate is a guaranteed interest rate.

65. The annuity product as claimed in claim 53 wherein the interest rate used to determine the desired periodic income payment is an assumed interest rate and the periodic income payment varies based on the earnings of selected investment accounts versus such assumed interest rate.

66. The annuity product as claimed in claim 53 wherein the interest rate used to determine the desired periodic income payment is an assumed interest rate and the period for payment of income varies based on the earnings of selected investment accounts versus such assumed interest rate.

67. The annuity product as claimed in claim 53 wherein the desired periodic income payment may be increased during the term of the annuity product by adding an additional deposit amount to the income annuity balance.

68. The annuity product as claimed in claim 53 wherein at least a portion of periodic income payments is dependent on the survival of one or more lives.
